(19) United States
(12) Patent Application Publication
(10) Pub. No.: US 2013/0248141 A1
(43) Pub. Date: Sep. 26, 2013

(54) DUCTING ARRANGEMENT AND METHOD FOR DIRECTING AIRFLOW TOWARD A RADIATOR

(71) Applicants: Michael W. Maurer, Dublin, OH (US); Christopher Meeks, Greensboro, NC (US); Jason A. Widmer, Marysville, OH (US); Karl Forster, Powell, OH (US); James Robinson, Delaware, OH (US); Michael R. Missig, Powell, OH (US)

(72) Inventors: Michael W. Maurer, Dublin, OH (US); Christopher Meeks, Greensboro, NC (US); Jason A. Widmer, Marysville, OH (US); Karl Forster, Powell, OH (US); James Robinson, Delaware, OH (US); Michael R. Missig, Powell, OH (US)

(73) Assignee: HONDA MOTOR CO., LTD., Tokyo (JP)

(21) Appl. No.: 13/429,807

(22) Filed: Mar. 26, 2012

(51) Int. Cl. B60H 1/26; B60H 1/32

(52) U.S. Cl. 165/44

(57) ABSTRACT

A front end structure for a vehicle includes a fascia member defining a forward end of a engine compartment and a radiator disposed in the engine compartment rearwardly spaced from the fascia member. The front end structure further includes a duct member receiving airflow from an opening in the fascia member and directing the airflow to a location adjacent the radiator for restricting airflow around the radiator.

### BACKGROUND

The present disclosure generally relates to a front end structure for a vehicle, and particularly relates to a ducting arrangement and method for directing airflow toward and through a radiator in a vehicle.

To maximize fuel economy and aerodynamics, efforts are being made to improve the efficiency of air entering vehicles. Specifically, cooling air entering through a front fascia (e.g., entering through the grille and/or other openings in the front fascia) and how such air flows through the vehicle is being managed. Optimally, all or substantially all of the air entering through the grille will be directed through the radiator for engine cooling. Unfortunately, however, a significant amount of air typically passes around the side of the radiator, hurting aerodynamics and cooling performance.

For example, with reference for FIG. 1, a front end structure 10 for a vehicle is schematically illustrated. The front end structure 10 includes a fascia member 12 defining a forward end of engine compartment and a radiator 14 disposed in the engine compartment rearwardly spaced from the fascia member 12. As shown by the arrows, airflow enters through grille openings 16, 18 in the fascia member 12 and is directed toward the radiator 14. Undesirably, some of the airflow directed toward the radiator 14 from the grille openings 16, 18 passes around lateral sides 20, 22 of the radiator and thus is not utilized for engine cooling, or at least not used for engine cooling via the radiator 14.

One countermeasure to address the issue of airflow passing around lateral sides 20, 22 of a radiator 14 is to employ air guides, such as plastic air guides or tabs (not shown in FIG. 1). These tabs can close any gaps around the radiator 14 and block airflow from passing around the radiator 14. The negative of this countermeasure is that it requires the use of additional components on the vehicle.

### SUMMARY

According to one aspect, a front end structure for a vehicle includes a fascia member defining a forward end of a engine compartment and a radiator disposed in the engine compartment rearwardly spaced from the fascia member. The front end structure further includes a duct member receiving airflow from an opening in the fascia member and directing the airflow to a location adjacent the radiator for restricting airflow around the radiator.

According to another aspect, a ducting arrangement for directing airflow toward a radiator in a vehicle includes a fascia member defining at least one lower opening therethrough and at least one upper opening therethrough. The at least one upper opening is aligned with an upper portion of the radiator such that airflow entering the at least one upper opening passes directly to the upper portion of the radiator. The ducting arrangement further includes at least one duct member associated with that at least one opening. The at least duct member has an inlet port arranged to receive airflow from the at least one lower opening and an exit port for discharging airflow received from the at least one lower opening. The exit port is arranged to discharge airflow at the upper portion of the radiator adjacent a lateral side of the radiator to maintain the airflow entering the at least one upper opening flowing into the radiator.

According to a further aspect, a method for directing airflow toward a radiator in a vehicle includes directing airflow from an upper opening defined in a fascia member toward an upper portion of the radiator; directing airflow from a lower opening defined in the fascia member below the upper opening toward the upper portion of the radiator; and further directing the airflow from the lower opening toward a location adjacent a lateral side of the radiator to prevent airflow from the upper opening from passing around the lateral side of the radiator.

### BRIEF DESCRIPTION OF THE DRAWINGS

FIG. 1 is a schematic plan view of a prior art front end structure of a vehicle showing airflow entering through a grille in a front fascia member passing around lateral sides of a radiator.

FIG. 2 is a front elevational view of a front end structure for a vehicle having a pair of duct members that receive airflow from respective openings in a fascia member and directs the received airflow to respective locations adjacent lateral sides of the radiator for restricting airflow around the radiator.

FIG. 3 is a cross-sectional view of the front end structure taken along the line 3-3 of FIG. 2.

FIG. 4 is a cross-sectional view of the front end structure taken along the line 4-4 of FIG. 2.

FIG. 5 is a perspective view showing the duct member and the radiator in isolation.

### DETAILED DESCRIPTION

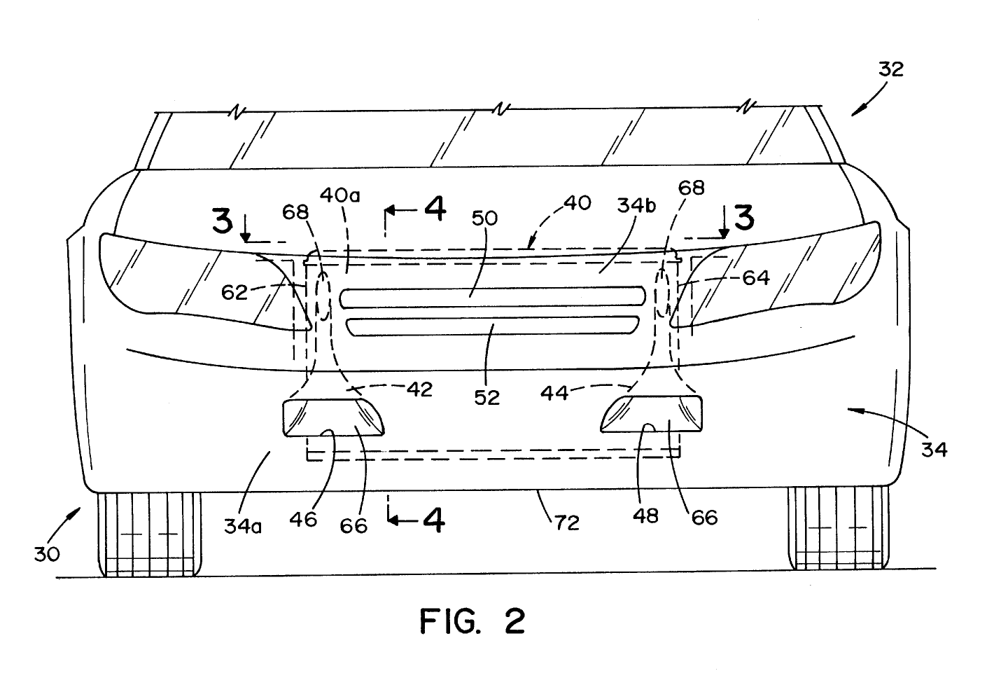

Referring now to the drawings, wherein the showings are for purposes of illustrating one or more exemplary embodiments and not for purposes of limiting same, FIGS. 2-4 illustrate a vehicle front end or front end structure 30 on a vehicle 32. The illustrated front end structure 30 includes a fascia member 34 defining a forward end 36 of a engine compartment 38 of the vehicle 32. A radiator 40 is disposed in the engine compartment rearwardly of the fascia member 34, and particularly rearwardly spaced from the fascia member 34. A condenser (not shown) can be disposed immediately forward of the radiator 40. The front end structure 30 additionally includes a ducting arrangement for directing airflow toward the radiator 40.

The ducting arrangement includes the fascia member 34 and at least one duct member associated with an opening in the fascia. In the illustrated embodiment, the at least one duct member is a pair of duct members 42, 44 that can be mirrored relative to one another within the front end structure 30. As will be described in more detail below, each of the duct members 42, 44 can receive airflow from an opening 46, 48 in the fascia member 34 and can direct the received airflow to a location adjacent the radiator 40 for restricting airflow around the radiator 40.

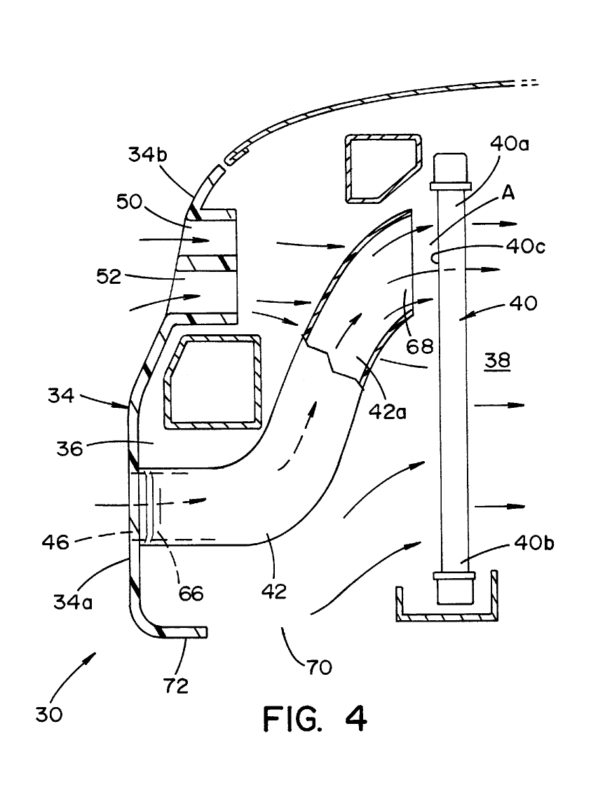

More particularly, the fascia member 34 defines at least one lower opening therethrough and at least upper opening therethrough. In the illustrated embodiment, the at least one lower opening is a pair of laterally spaced apart lower openings 46, 48 defined in a lower portion 34a of the fascia member 34 and the at least one upper opening is a grille formed of an upper opening 50 and a lower opening 52 defined in an upper portion 34b of the fascia member 34. The lower openings 46, 48 generally laterally flank the upper openings 50, 52, which can also be referred to as grille openings. Also in the illustrated embodiment, the duct member 42 can receive airflow from the opening 46 in the fascia member 34 and direct the received airflow to a location A adjacent the radiator (e.g., adjacent a first lateral side of the radiator) to restrict airflow around the radiator 40. Likewise, the duct member 44 can receive airflow from the opening 48 in the fascia member 34 and direct the received airflow to another or second location B adjacent the radiator (e.g., adjacent a second lateral side of the radiator) to restrict airflow around the radiator. As shown in FIG. 4, the at least one upper opening can be aligned with an upper portion 40a of the radiator 40 such that airflow entering the at least one upper opening passes directly to the upper portion 40a of the radiator.

As mentioned, the at least one duct member (e.g., first and second duct members 42, 44) can be associated with the at least one lower opening (e.g., first and second lower openings 46, 48). As will be described in more detail below, the at least one duct member can have an inlet port arranged to received airflow from the at least one lower opening and an exit or outlet port for discharging airflow received from the at least one lower opening, wherein the exit port is arranged to discharge airflow at the upper portion 40a of the radiator adjacent a lateral side of the radiator to maintain the airflow entering the at least one upper opening flowing into the radiator 40. The inlet port can be vertically aligned with a lower portion 40b of the radiator 40 and the exit port can be vertically aligned with an upper portion 40a of the radiator 40.

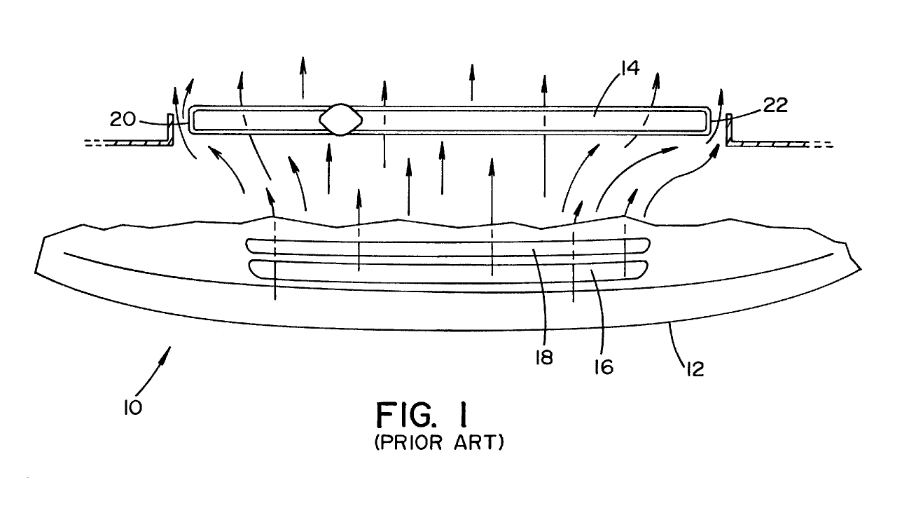

More particular, and referring to the illustrated embodiment, each of the lower openings 46, 48 is an opening defined in the lower portion 34a of the fascia member 34 and is aligned, at least vertically, with a lower portion 40b of the radiator 40. The duct members 42, 44 receive airflow, respectively, from the openings 46, 48 in the fascia member 34 and direct the received airflow to respective locations A, B adjacent the radiator 40 for restricting airflow around the radiator. In particular, the respective locations A, B adjacent the radiator 40 can be disposed adjacent the upper portion 40a of the radiator, which is located above the lower portion 40b of the radiator 40. More specifically, each of the locations A, B can be disposed adjacent a lateral side 62, 64 of the radiator 40 for forming an air curtain adjacent the lateral sides 62, 64 of the radiator 40 that causes other airflow incoming toward the radiator 40 (e.g., airflow entering through the grille openings 50, 52) to pass through the radiator 40 instead of passing around the lateral sides 60 62 of the radiator 40 as occurs in the prior art arrangement depicted in FIG. 1.

As already described, the upper openings 50, 52 are defined in the upper portion 34b of the fascia member, and particularly above the lower openings 46, 48 defined in the lower portion 34a of the fascia member 34. The upper openings 50, 52 can be aligned, at least vertically, with the upper portion 40a of the radiator 40 such that airflow entering the upper openings 50, 52 passes toward the upper portion 40b of the radiator 40 and is prevented from passing around the lateral sides 62, 64 of the radiator by air curtains formed by airflow exiting the duct members 42, 44. Advantageously, the front end structure 10 and ducting arrangement thereof illustrated in FIGS. 2-5 allows airflow from the upper openings 50, 52 to be prevented from passing around lateral sides 60, 62 of the radiator and does not require the use of any plastic tabs (i.e., airflow is prevented from passing around the radiator without the use of tabs). This can result in cost savings and weight savings for the vehicle 32.

Each of the duct members 44, 46 includes a respective inlet port 66 at the respective openings 46, 48 and an respective exit port 68 at the respective locations A, B adjacent the radiator 40. In particular, the exit port 68 of the duct member 42 is disposed at the first location A, which is located or disposed adjacent the first lateral side 62 of the radiator 40, and the exit port 68 of the second duct member 44 is disposed adjacent the second location B, which is located or disposed adjacent the second, opposite lateral side 64 of the radiator 40. As already mentioned, the first and second duct members 42, 44 create air curtains at the first and second locations A, B when airflow passes through the first and second duct members 42, 44. In particular, the exit ports 68 are arranged such that airflow exiting the exit ports 68 forms a respective air curtains at or around lateral sides 62, 64 of the radiator 40 that prevents the airflow entering through the upper openings 50, 52 from bypassing the radiator and flowing around the lateral sides 62, 64 of the radiator 40.

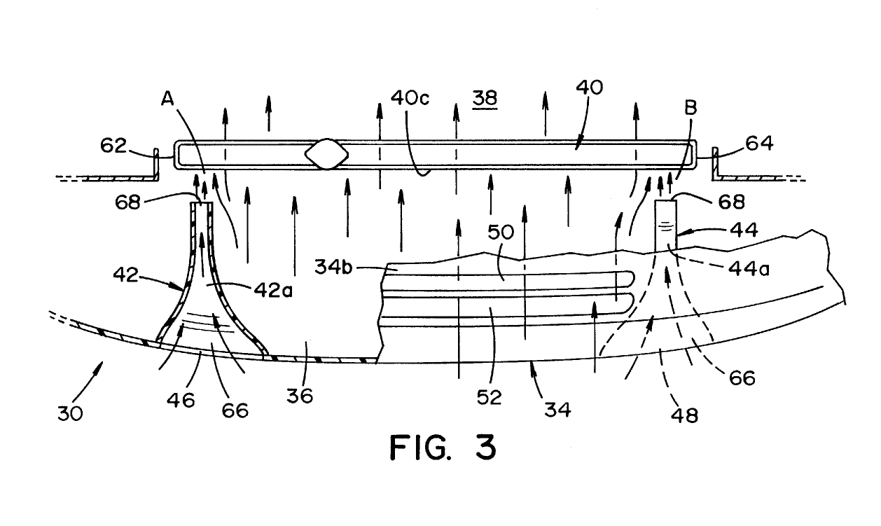

In the illustrated embodiment, the exit ports 68 of the first and second duct members 42, 44 are defined in a plane that is substantially parallel to a forward face 40c of the radiator 40 (see FIG. 3). By this arrangement, the first duct member 42 has an exit port 68 adjacent the first lateral side 62 of the radiator 40 at the location A and the second duct member 44 has its exit port 68 adjacent the second lateral side 64 of the radiator 40 at the location B. Airflow exiting the first and second duct members 42, 44 via the respect exit ports 68 generally restricts airflow entering the at least one upper opening (e.g., openings 50, 52) from passing around the lateral sides 62, 64 of the radiator 40. Also in the illustrated embodiment, the inlet port 66 of each duct member 42, 44 is spaced apart vertically from the respective outlet port 68 of each duct member 42, 44. In particular, the inlet ports 66 are disposed at a first elevation and the exit ports 68 are disposed at a second, higher elevation relative to the inlet ports 66.

As shown in FIG. 3 with respect to duct member 42 and opening 46, the inlet ports 66 of the duct members 42, 44 can be substantially sealed to the fascia member 34 and with the respective openings 46, 48 such that all airflow entering the openings 46, 48 in the fascia member 34 necessarily enters the inlet ports 66 of the duct members 42, 44. Additionally, each of the inlet ports 66 can have a cross-sectional area that substantially matches a cross-sectional area of the respective openings 46, 48 defined in fascia member 34. Also, as shown in the illustrated embodiment, each of the duct members 42, 44 can define a duct passageway 42a, 44a that is substantially enclosed from the inlet port 66 to the exit port 68. Accordingly, only the inlet port 66 and the exit port 68 permit entry and exit for airflow in the duct passageways 42a, 44a.

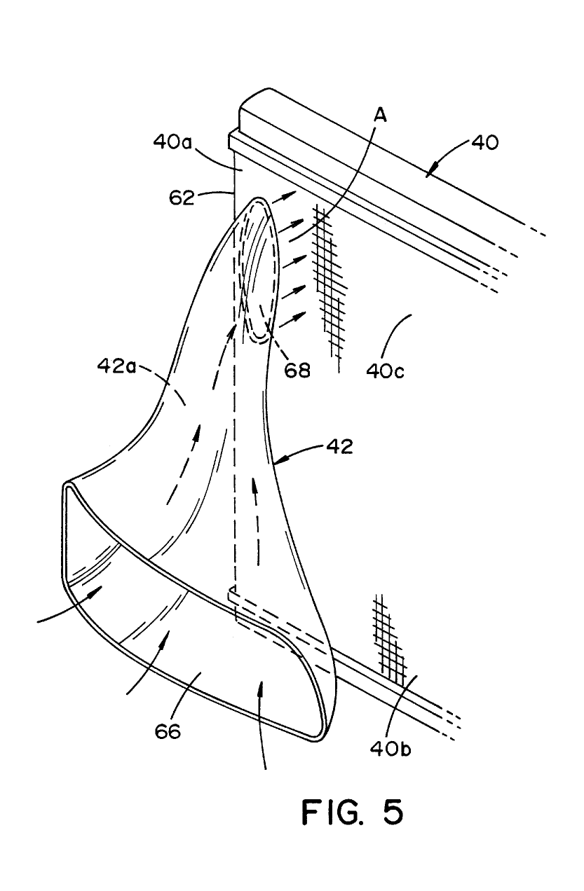

With additional reference to FIG. 5, the inlet ports 66 of the duct members 42, 44 can each have cross-sectional areas that are respectively greater than cross-sectional areas of the respective outlet ports 68 for increasing a velocity of the airflow received and directed by the duct members 42, 44. By way of example, the cross-sectional areas of the inlet ports 66 can be two times more greater than the cross-sectional areas of the outlet ports 68 and, in the illustrated embodiment, is at least three times larger than the respective exit ports 68. The increased velocity imparted to the airflow passing through the duct members 42, 44 enhances the curtain effect that restricts the airflow from the grille openings 50, 52 from passing around the radiator 40.

Optionally, as best shown in FIG. 4, an underside air inlet opening 70 can be defined in an underside 72 of the vehicle 32 for allowing additional airflow to pass to the radiator 40. This can be referred to as a bottom breather application. One advantage of the front end structure 30 and ducting arrangement described herein is that it can increase the efficiency of such a bottom breather application because it does not adversely impact any airflow passing to the radiator 40 from the inlet opening 70.

A method for directing airflow toward a radiator in a vehicle will now be described. In particular, the method will be described in association with the front end structure 10 and ducting arrangement of FIGS. 2-5, though this is not required. In the method, airflow is directed from the upper opening, such as openings 50, 52 defined in the fascia member 34, toward the upper portion 40a of the radiator 40. Airflow is also directed from lower openings 46, 48 defined in the fascia member 34 below the upper openings 50, 52 toward the upper portion 40a of the radiator. The airflow is further directed from the lower openings 46, 48 toward respective locations adjacent lateral sides 62, 64 of the radiator 40 to prevent airflow from the upper portions 50, 52 from passing around the lateral sides 62, 64 of the radiator 40.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A front end structure for a vehicle, comprising:
a fascia member defining a forward end of an engine compartment;
a radiator disposed in the engine compartment rearwardly spaced from the fascia member; and
a duct member receiving airflow from an opening in the fascia member and directing the airflow to a location adjacent the radiator for restricting airflow around the radiator.

2. The front end structure of claim 1 wherein the opening is defined in a lower portion of the fascia member and is aligned with a lower portion of the radiator, the location adjacent the radiator is disposed adjacent an upper portion of the radiator located above the lower portion of the radiator.

3. The front end structure of claim 2 wherein the location is disposed adjacent a lateral side of the radiator for forming an air curtain adjacent the lateral side of the radiator that causes other airflow incoming toward the radiator to pass through the radiator instead of passing around the lateral side of the radiator.

4. The front end structure of claim 3 wherein an upper opening is defined in an upper portion of the fascia member above the opening defined in the lower portion, the upper opening aligned with the upper portion of the radiator such that airflow entering the upper opening passes toward the upper portion of the radiator and prevented from passing around the lateral side of the radiator by the air curtain formed by the airflow exiting the duct member.

5. The front end structure of claim 1 wherein the duct member has an inlet port at the opening and an exit port at the location, the inlet port having a cross-sectional area that is greater than a cross-sectional area of the outlet port for increasing a velocity of the airflow received and directed by the duct member.

6. The front end structure of claim 5 wherein the inlet port has a cross-sectional area substantially matching a cross-sectional area of the opening defined in the fascia member, and wherein the cross-sectional area of the inlet port is more than two times greater than the cross-sectional area of the outlet port.

7. The front end structure of claim 5 wherein the duct member defines a duct passageway that is substantially enclosed from the inlet port to the exit port.

8. The front end structure of claim 1 wherein the duct member is a first duct member, the opening is a first opening and the location is a first location, the front end structure further including a second duct member receiving airflow from a second opening in the fascia member and directing the airflow to a second location adjacent the radiator for restricting airflow around the radiator, the first location disposed adjacent a first lateral side of the radiator and the second location disposed adjacent a second, opposite lateral side of the radiator, the first and second duct members creating air curtains at the first and second locations when airflow passes through the first and second duct members.

9. The front end structure of claim 8 wherein the first and second duct members have exit ports defined in a plane that is substantially parallel to a forward face of the radiator.

10. The front end structure of claim 1 wherein an inlet port of the duct member is substantially sealed with the opening such that all airflow entering the opening in the fascia member enters the inlet port of the duct member.

11. A ducting arrangement for directing airflow toward a radiator in a vehicle, comprising:
a fascia member defining at least one lower opening therethrough and at least one upper opening therethrough, the at least one upper opening aligned with an upper portion of the radiator such that airflow entering the at least one upper opening passes directly to the upper portion of the radiator; and
at least one duct member associated with the at least one lower opening, the at least one duct member having an inlet port arranged to receive airflow from the at least one lower opening and an exit port for discharging airflow received from the at least one lower opening, the exit port arranged to discharge airflow at the upper portion of the radiator adjacent a lateral side of the radiator to maintain the airflow entering the at least one upper opening flowing into the radiator.

12. The ducting arrangement of claim 11 wherein the exit port is arranged such that airflow exiting the exit port forms an air curtain that prevents the airflow from the at least one upper opening from bypassing the radiator and flowing around the lateral side of the radiator.

13. The ducting arrangement of claim 11 wherein the at least one upper opening is a grille formed of an upper opening and a lower opening extending through the fascia member.

14. The ducting arrangement of claim 11 wherein the at least one lower opening is a pair of laterally spaced apart lower openings defined in a lower portion of the fascia member, the lower openings generally laterally flanking the at least one upper opening, and further wherein the at least one duct member is a pair of duct members each associated with a respective one of the lower openings.

15. The ducting arrangement of claim 14 wherein the pair of duct members includes a first duct member having an exit port adjacent a first lateral side of the radiator and a second duct member having an exit port adjacent a second lateral side of the radiator, airflow exiting the first and second duct members generally restricting airflow entering the at least one upper opening from passing around the lateral sides of the radiator.

16. The ducting arrangement of claim 14 wherein the inlet port is spaced apart vertically from the outlet port.

17. The ducting arrangement of claim 16 wherein the exit port has a reduced area relative to the inlet port that increases a velocity of the airflow passing from the inlet port to the exit port.

18. The ducting arrangement of claim 11 wherein airflow from the at least one upper opening is prevented from passing around the lateral side of the radiator without the use of a tab.

19. The ducting arrangement of claim 11 further including an underside air inlet opening defined in an underside of the vehicle for allowing additional airflow to pass to the radiator.

20. A method for directing airflow toward a radiator in a vehicle, comprising:
directing airflow from an upper opening defined in a fascia member toward an upper portion of a radiator;
directing airflow from a lower opening defined in the fascia member below the upper opening toward the upper portion of the radiator; and
further directing the airflow from the lower opening toward a location adjacent a lateral side of the radiator to prevent airflow from the upper opening from passing around the lateral side of the radiator.
